(19) United States
(12) Patent Application Publication
(10) Pub. No.: US 2018/0169845 A1
(43) Pub. Date: Jun. 21, 2018

(54) Puller Tool and Method Therefor

(71) Applicant: James Spencer, Suffolk, VA (US)

(72) Inventor: James Lawson Spencer, III, Suffolk, VA (US)

(21) Appl. No.: 14/799,063

(22) Filed: Jul. 14, 2015

Related U.S. Application Data
(60) Provisional application No. 62/024,100, filed on Jul. 14, 2014.

(51) Int. Cl. B25B 27/02; B25B 27/00; B25B 13/48

(52) U.S. Cl. CPC B25B 27/02; B25B 13/48; B25B 27/0007

(57) ABSTRACT

The invention provides device and method for removing a basket for a washer. The device comprises a structure for attaching to a basket disposed on a shaft of a washer, and a component threadably movable with respect to the structure to move the basket with respect to the shaft. The method comprises attaching the structure to a basket disposed on a shaft of a washer, and rotating the threadably movable component with respect to the structure to axially engage the shaft and move the basket with respect to the shaft.

### CROSS-REFERENCE TO RELATED APPLICATIONS

This application claims priority to prior U.S. Provisional Patent Application No. 62/024,100 filed Jul. 14, 2014, the contents of which (including all attachments filed therewith) is hereby incorporated by reference in its entirety.

### BACKGROUND OF THE INVENTION

### 1. Field of the Invention

Generally, exemplary embodiments of the present invention relate to the fields of tools and methods used to facilitate repair or replacement of components or parts for commercial or industrial appliances such as washing machines. Exemplary implementations of certain embodiments of the invention provide devices and methods for removing wash baskets from direct drive washers.

### 2. Discussion of the Background of the Invention

Conventional methods for removing wash baskets from washers require two people to properly hold and extract the basket, particularly in cases where the wash basket is stuck inside the washer. FIG. 6A illustrates a typical wash basket configured inside a conventional direct drive washer with axial attachment as shown by the arrow. Currently, there are no tools available to facilitate the extraction of the basket from the washer when the basket is stuck, for example to the shaft of a washing machine drive mechanism. Accordingly, conventional methods and technique have at least the drawbacks of requiring more than one person to properly extract the basket from the washer, and lacking of tools to facilitate extraction of stuck baskets.

### SUMMARY OF THE INVENTION

Exemplary embodiments of the present invention address at least these issues by providing a device, as illustrated in FIG. 1, which can be attached to the basket without modifying the basket or the washer in which it is disposed.

According to an exemplary embodiment of the present invention, a device advantageously provides a holder sufficient for one person to properly support the basket for removal from the washer.

According to yet another exemplary embodiment of the present invention, a device advantageously includes a movable component to facilitate extraction of the basket which may be stuck to the support or drive mechanism of the washer.

According to yet another exemplary embodiment of the present invention, a device advantageously includes a holder integrating a structure for facilitating extraction of the basket.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a three-dimensional drawing illustrating a device according to an exemplary embodiment of the present invention.

FIG. 2 is a schematic diagram illustrating a top view of a device according to an exemplary embodiment of the present invention.

FIG. 3 is a schematic diagram illustrating a bottom view of a device according to an exemplary embodiment of the present invention.

FIG. 4A is a schematic diagram illustrating a sectional view of a device according to an exemplary embodiment of the present invention illustrated in FIG. 2.

FIG. 4B is a schematic diagram illustrating a sectional view of a device according to an exemplary embodiment of the present invention illustrated in FIG. 3.

FIGS. 5A, 5B, 5C, 5D, 5E and 5F are schematic diagrams illustrating operation and sectional views of exemplary implementations of devices according to exemplary embodiments of the present invention.

FIGS. 5G and 5H are schematic diagrams illustrating operation, as well as top and sectional views of an exemplary implementation of devices according to exemplary embodiments of the present invention.

FIGS. 6A, 6B, 6C, 6D, and 6E are representative illustrations of implementation, operation, and application of methodologies and devices according to exemplary embodiments of the present invention.

### DETAILED DESCRIPTION OF EXEMPLARY EMBODIMENTS

The matters exemplified in this description are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

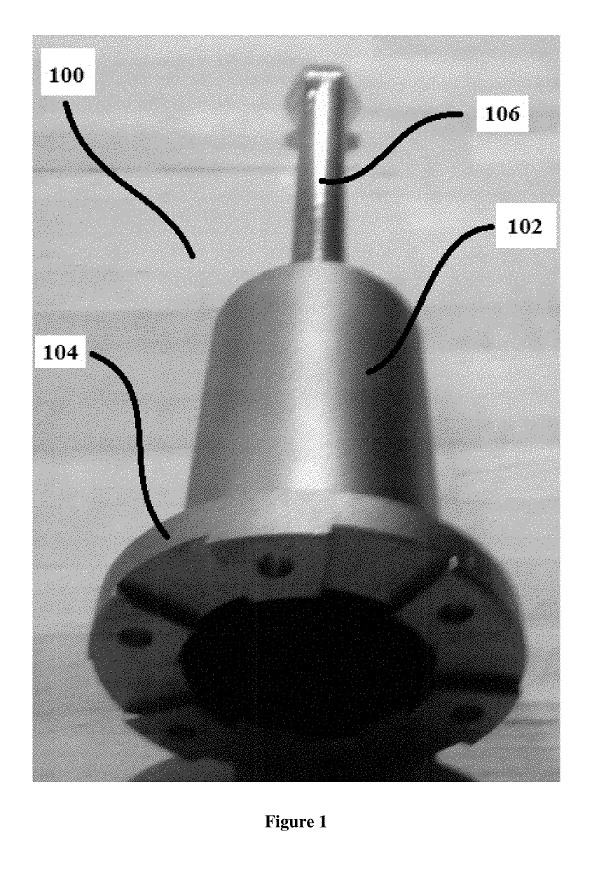

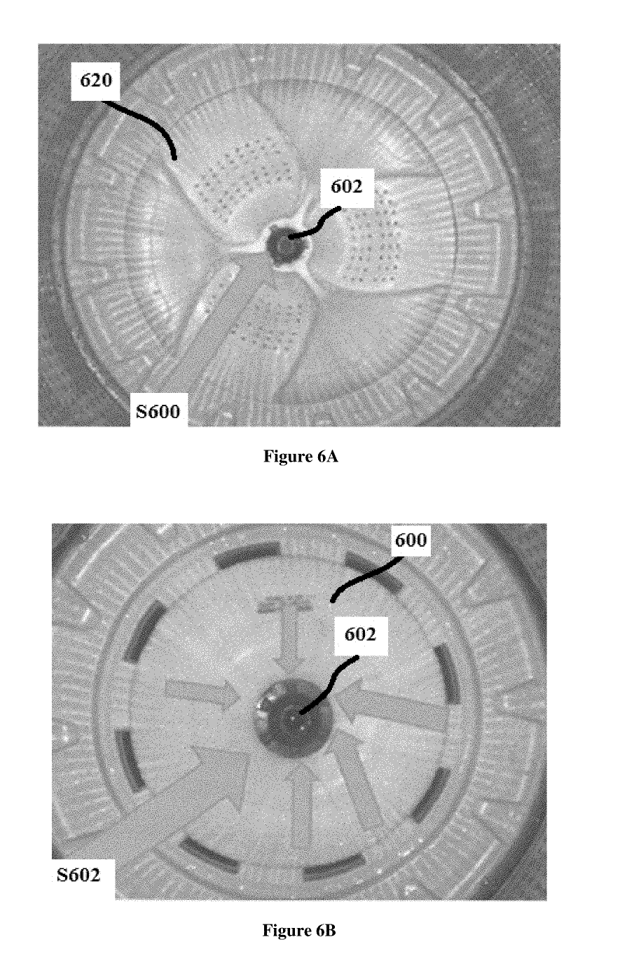

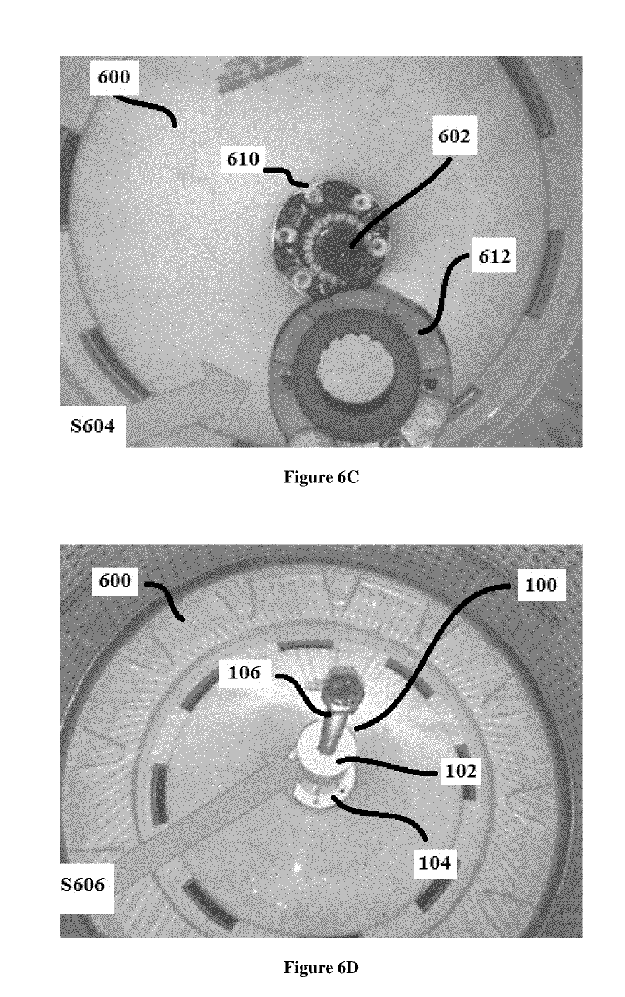

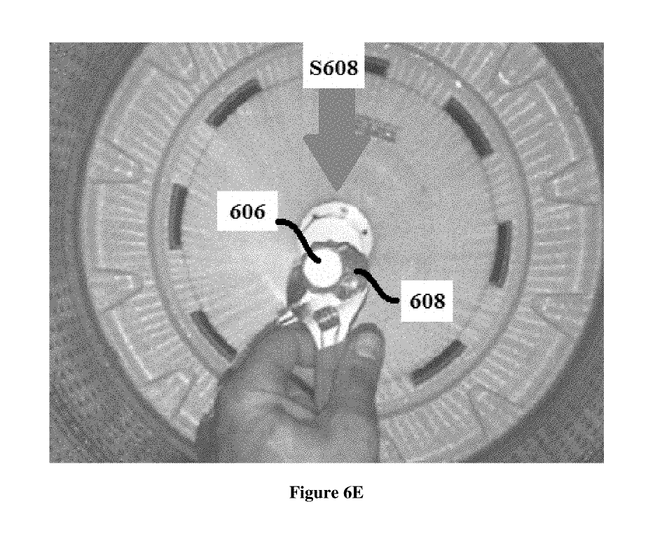

In an exemplary implementation of FIG. 1, a device 100 according to the present invention includes a structure 102 with a portion 104 for secure attachment to a basket 600 of a washer, as illustrated in the example of FIG. 6D. According to an exemplary implementation of FIG. 1, structure 102 is essentially cylindrical with a hollow portion through which a component 106 threadably moves in an essentially axial direction. However, a cylindrical shape is merely exemplary, and any other shape with a hollow portion sufficient to accommodate a shaft 602 of a washer drive mechanism (see FIGS. 6A-6C) so that the component 106 axially engages therewith when threadably moving via structure 102, is within the scope of the present invention.

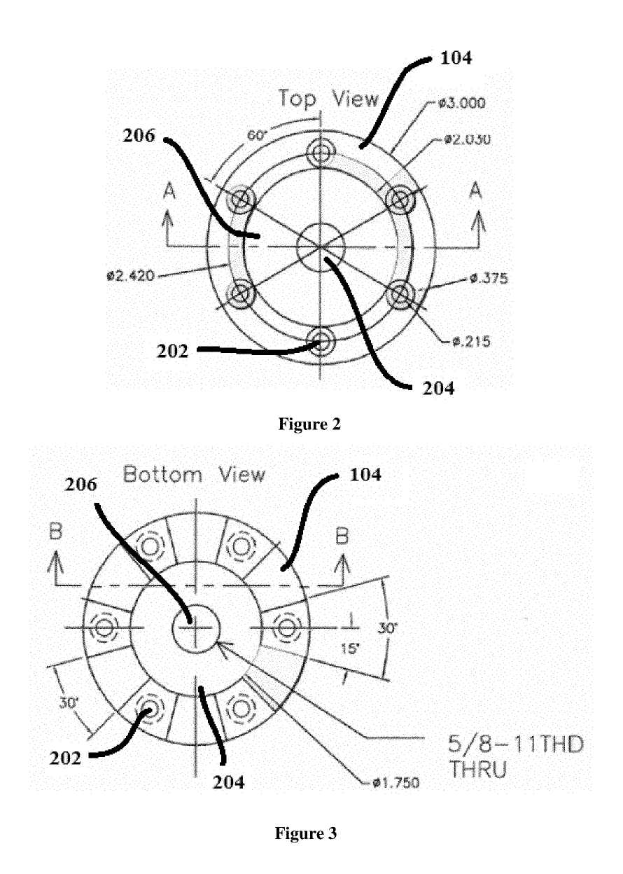

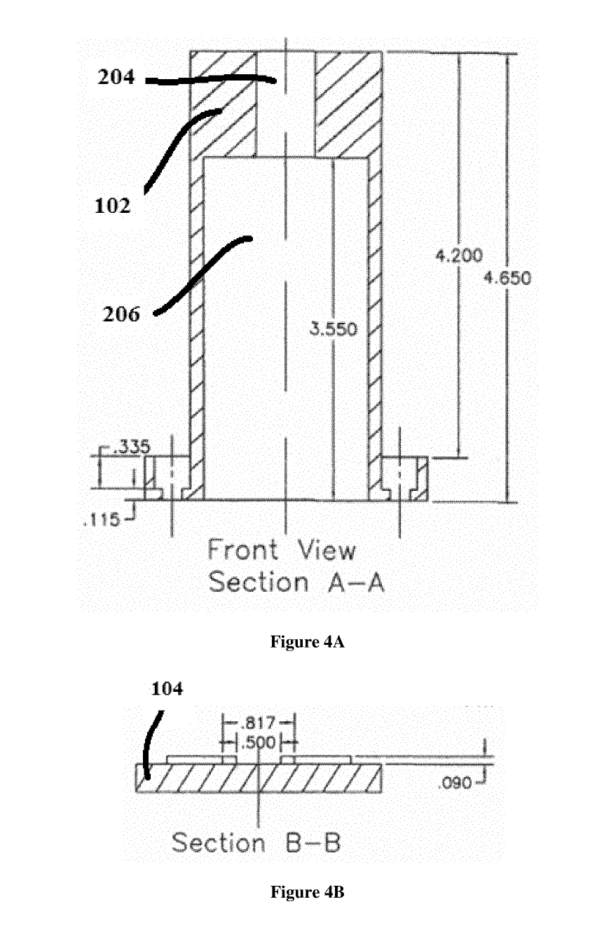

According to an exemplary embodiment of the present invention where structure 102 comprises a non-limiting essentially cylindrical shape, a top view of such a structure is illustrated in FIG. 2 and a bottom view is illustrated in FIG. 3. In the exemplary implementation shown in FIGS. 2 and 3, openings 202 are provides in structure 102 for secure attachment at part 610 of basket 600 as shown in the examples of FIGS. 6C and 6D. While the examples illustrated herein show a six-point attachment at 202, any number of attachment points, for example 2 or 3, may be sufficient to ensure secure attachment of structure 102 to basket 600 such that basket 600 can be manually removed from washer by holding on to structure 102. As further illustrated in the examples of FIGS. 2 and 3, structure 102 includes a hollow portion 206 for accommodating shaft 602, and opening 204 for threadable attachment and movement there through of component 106. FIGS. 4A and 4B are section views of the structure 102 illustrated in the examples of FIGS. 2 and 3. As noted above, all of the dimensions provided in FIGS. 2 and 3 are illustrative, non-limiting examples.

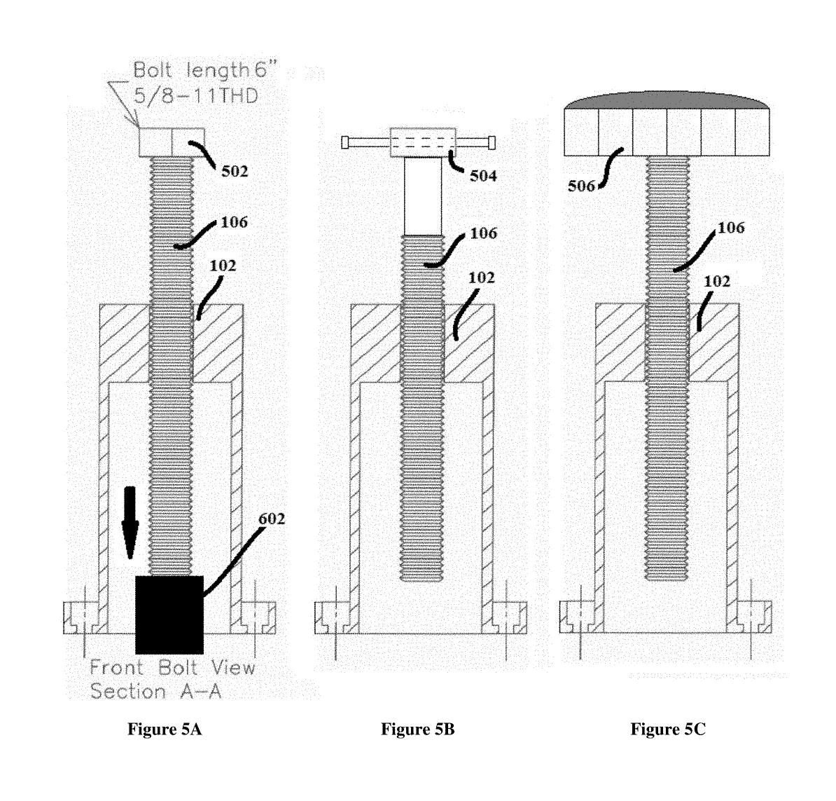

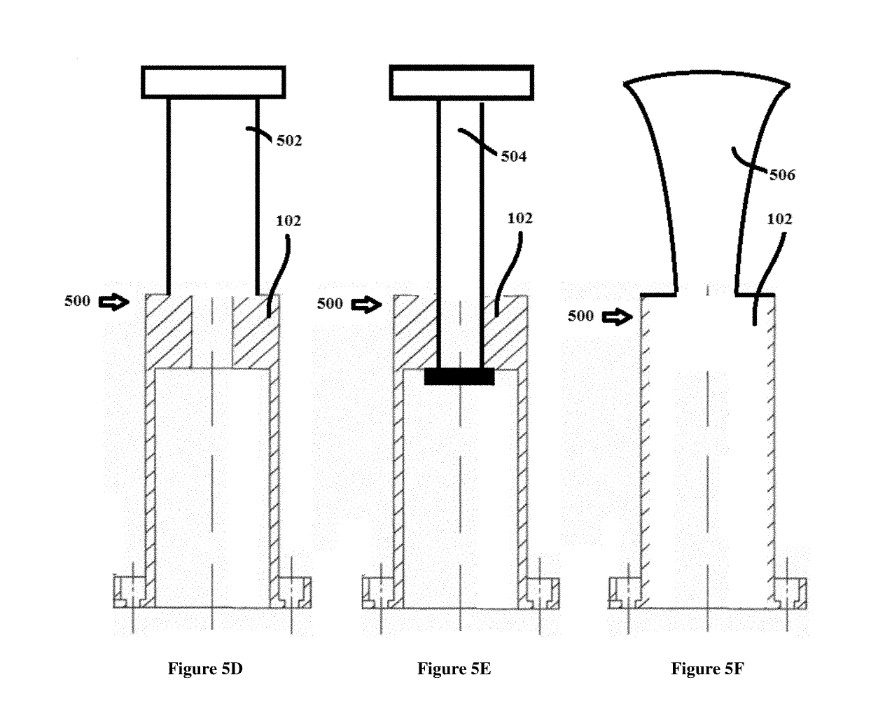

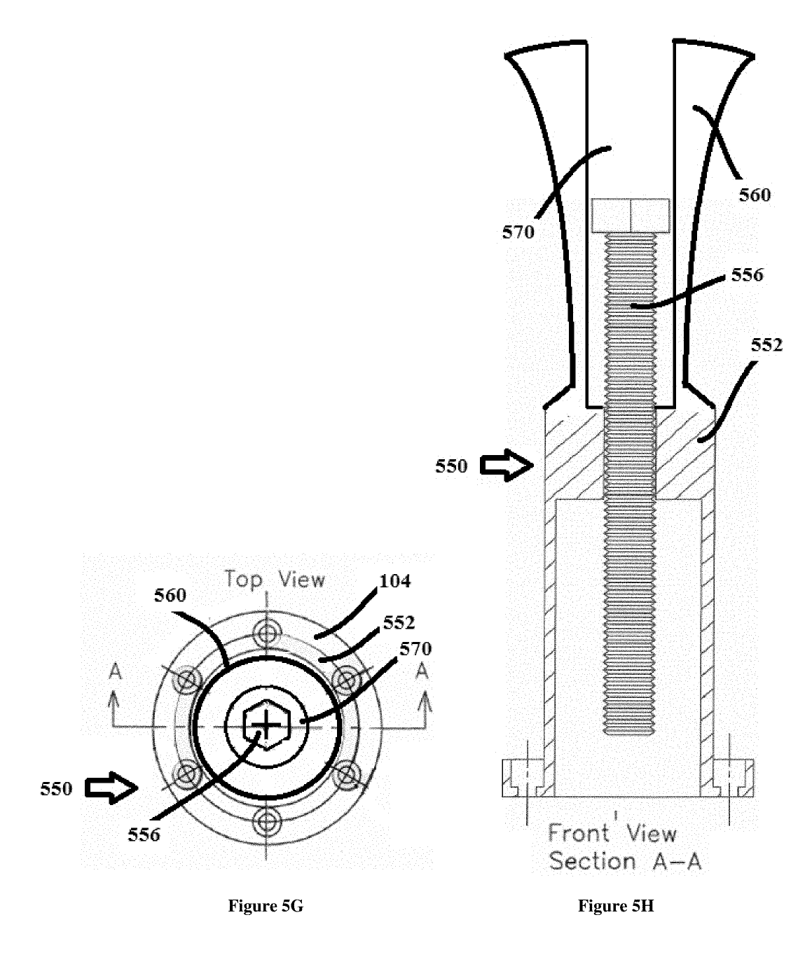

According to exemplary embodiments of the present invention as illustrated in FIGS. 5A-5C, component 106 can be configures as a bolt 502 threadably moving with respect to structure 102 to axially engage shaft 602 accommodated in hollow portion of structure 102 when attached to basket. In an exemplary implementation bolt 502 can be threadably moved by engaging and turning wrench 608, as illustrated in FIG. 6E. According to other exemplary implementations of the present invention, component 106 can include different types of handles, such as 504 and 506 for threadably moving component 106 with respect to structure 102. As further illustrated in the example of FIGS. 5A-5C the amount of thread provided on component 106 can very as long as it is sufficient to facilitate disengagement of basket 600 from shaft 602 when component 106 is threadably moved with respect to structure 102.

According to yet another exemplary embodiment of the present invention, a device 500 does not include a component 106 as illustrated in FIGS. 5D-5F. In an exemplary implementation of the present invention, for applications where basket 600 can be easily removed off of the shaft 602, device 500 comprises a structure 102 and a fixed or removable handle 502, 504 or 506 attached thereto.

According to yet another exemplary embodiment of the present invention, as illustrated in FIGS. 5G and 5H, a device 550 includes structure 552, component 556, and handle 560. In an exemplary implementation, component 556 threadably moves with respect to structure 552 and freely moves with respect to handle 560 via the opening 570. Component 556 can be rotated for threadable movement with respect to structure 552 by, for example a socket wrench engaging component 556 or, for example a screwdriver.

A method of removing a basket from a washer according to an exemplary embodiment of the present invention includes the following steps described with reference to the examples of FIGS. 6A-6E for removing a basket stuck in a washer:

Step S600: removing agitator bolt and lift off agitator 620;

Step S602: removing six screws from hub cover 612 attached to basket 600;

Step S604: lifting hub cover 612 off of the basket 600;

Step S606 attaching device 100 to basket 600 by attaching portion 104 of structure 102 via openings 202 to six screw attachment points of basket 600;

Step S608 threadably moving component 606 by engaging and rotating wrench 608 to push basket 600 off of shaft 602.

While the present invention has been shown and described with reference to certain exemplary embodiments thereof, it will be understood by those skilled in the art that various changes in form and details may be made therein without departing from the spirit and scope of the present invention.

In addition, the drawing figures that follow further describes non-limiting examples of implementations of certain exemplary embodiments of the present invention and aid in the description of technology associated therewith. Any specific dimensions or measurements provided in the drawings are exemplary and not intended to limit the scope or content of the inventive design or methodology as understood by artisans skilled in the relevant field of invention.

Other objects, advantages and salient features of the invention will become apparent to those skilled in the art from the details provided, which, taken in conjunction with the annexed drawing figures, disclose exemplary embodiments of the invention.

I claim:

1. A device for removing a basket for a washer comprising:
a structure for attaching to a basket disposed on a shaft of a washer; and
a component threadably movable with respect to said structure to move said basket with respect to said shaft.

2. A method of removing a basket for a washer comprising:
attaching a structure to a basket disposed on a shaft of a washer; and
rotating a threadably movable component with respect to said structure to axially engage said shaft and move said basket with respect to said shaft.
